(19) United States
(12) Patent Application Publication
(10) Pub. No.: US 2012/0321259 A1
(43) Pub. Date: Dec. 20, 2012

(54) LIGHT-TRANSMITTABLE COMPOSITE TUBE

(76) Inventors: Luke Lu, South Pasadena, CA (US); Toshihiro Tokizawa, Tokyo (JP); Ching-Yuan Hwang, Taichung City (TW)

(21) Appl. No.: 13/159,437

(22) Filed: Jun. 14, 2011

(51) Int. Cl. G02B 6/04

(52) U.S. Cl. 385/115

(57) ABSTRACT

A light-transmittable composite tube includes a plurality of optical fibers and a plastic material. Each of the optical fibers has a light entrance end and a light exit end. Light enters the light entrance end and emits from the light exit end. The plastic material is set around and combined with side surfaces of the optical fibers in a composite form to fix relative positions of the optical fibers to form a tubular structure, serving as a fiber/plastic composite light guide tube. The fiber/plastic composite light guide tube has a light receiving end opening and a light emitting end opening, wherein the light exit ends of the fibers are arranged to distribute in the light emitting end opening and face outward of the light emitting end opening.

### (a) TECHNICAL FIELD OF THE INVENTION

The present invention generally relates to a light-transmittable composite tube, and more particularly to a tube formed by being encircled by optical fibers.

### (b) DESCRIPTION OF THE PRIOR ART

At a dark site, it is often difficult to draw and discharge objects with a tube simply due to the insufficiency of lighting.

For example, when a dentist carries out an oral cavity surgery operation, blood from the wound and saliva are mixed and accumulated in the oral cavity. This may block eye sight and influence the performance of the surgery operation. A drawing device is often employed to draw away the blood and saliva with a tube connected to the drawing device during the performance of the operation.

However, due to the limited extent that human mouth may open and also due to the existence of teeth, there are various dark areas inside the oral cavity, whereby the dentist needs to rotate the head of the patient in order to let light get into the oral cavity for identification of the sites where the blood and the saliva accumulate. This is troublesome to both the patient and the dentist.

Further, certain invading treatments may cause similar problems. For example, treatment performed with for example an endoscope, a gastroscope, a colonoscope require an additional light source attached to a side wall of the tube. In an invading treatment, the larger the tube size is, the more uncomfortable the patient may feel. Further, the light source projects outside the tube, thereby adding weight to a front end of the tube and increasing the difficulty of moving the tube.

### SUMMARY OF THE INVENTION

In view of the above problems, the present invention provides a light-transmittable composite tube, which is formed by combining optical fibers and plastic material as a composite tubular structure, wherein light may be received from an end of the tubular structure and emit from an opposite end of the tubular structure so that a light source additionally mounted to a front end of the tube is no longer needed, weight concentration at an end of the tube is eliminated, avoiding a projecting light emitting body is no longer required in operating the tube, and further, light is allowed to irradiate the front end of the tube from the front side of the tube to provide the best result of lighting thereby facilitating control and handling of any situation.

The present invention comprises a plurality of optical fibers and a plastic material, wherein each of the optical fibers has a light entrance end and a light exit end. Light enters the light entrance end and emits from the light exit end. The plastic material is set around and combined with side surfaces of the optical fibers in a composite form to fix relative positions of the optical fibers to form a tubular structure, which will be referred to as a fiber/plastic composite light guide tube. The fiber/plastic composite light guide tube has a light receiving end opening and a light emitting end opening, wherein the light exit ends of the fibers are arranged to distribute in the light emitting end opening and face outward of the light emitting end opening.

Since the present invention does not need to additionally mount a light emitting object outside a conventional tube, the present invention allows of direct formation of a desired thickness or shape, making the operation thereof easy. Further, the present invention is applicable to an endoscope, dentistry equipments, or maintenance and assembling of machinery, making the application thereof diversified.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an embodiment according to the present invention.

FIG. 2 is a cross-sectional view showing the embodiment of the present invention.

FIG. 3 is a partial cross-sectional view showing distribution of optical fibers according to the embodiment of the present invention.

FIG. 4 is an end view showing a light emitting end opening according to the embodiment of the present invention.

FIG. 5 is an end view showing a light receiving end opening according to the embodiment of the present invention.

FIG. 6 is a side elevational view illustrating the embodiment of the present invention fit into a handgrip.

FIG. 7 is schematic view illustrating another arrangement of the light entrance end according to an embodiment of the present invention.

FIG. 8 is an end view showing the light entrance end of the arrangement of FIG. 7.

FIG. 9 is a schematic view illustrating a circular arrangement of light source.

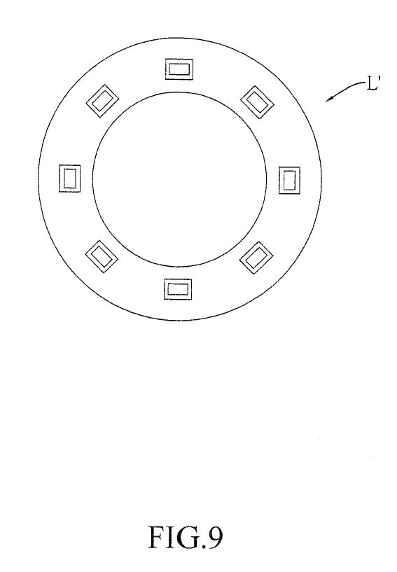

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

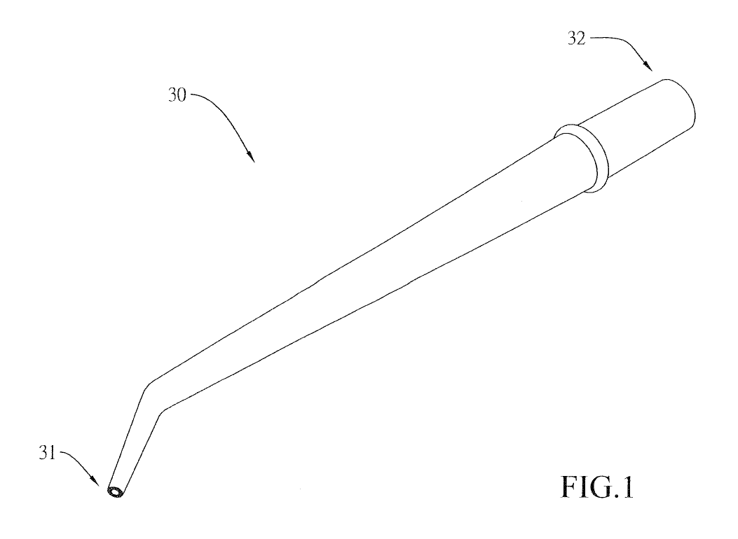

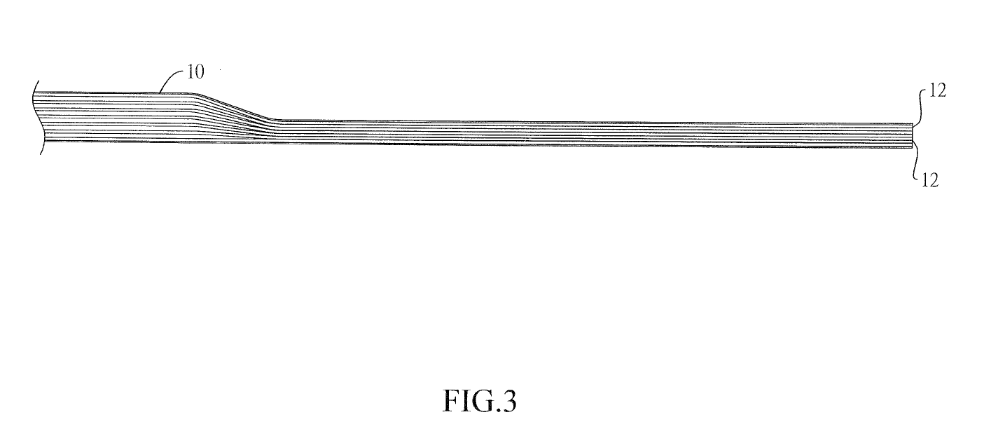

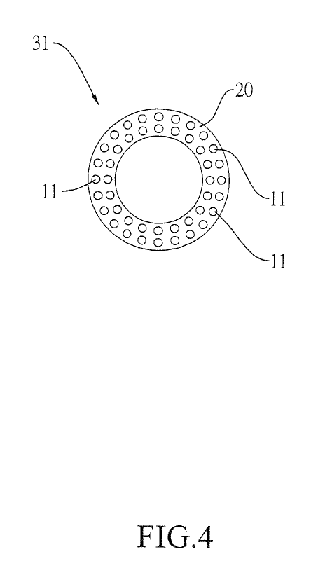

Reference is now made to FIGS. 1-4, which are respectively a perspective view, a cross-sectional view, and a partial enlarged cross-sectional view of an embodiment according to the present invention, and an end view showing a light emitting end opening according to the present invention.

In an embodiment of the present invention, a light-transmittable composite tube is provided, which comprises a plurality of optical fibers 10 and a plastic material 20.

Each of the optical fibers 10 has a light exit end 11 and a light entrance end 12. Light enters the light entrance end 12 and emits from the light exit end 11.

The plastic material 20 is set around and combined with side surfaces of the optical fibers 10 in a composite form to fix relative positions of the optical fibers 10 to form a tubular structure, which is referred to as a fiber/plastic composite light guide tube that has a light emitting end opening 31 and a light receiving end opening 32. The light exit ends 11 are arranged to distribute in and preferably along the light emitting end opening 31 and the light exit ends 11 face outward of the light emitting end opening 31.

The optical fibers 10 is combined with the plastic material 20 in a composite form, whereby when light enters the light entrance ends 12, the light transmits in the interiors of the optical fibers 10 in a direction toward the light exit ends 11, and then emits from the light exit ends 11 to irradiate at and light the front side.

Besides being used as a tube, the embodiment of the present invention is also applicable to a conveyance object, and may even allows of combination with a light source or an image pick-up device at the light receiving end opening 32 for lighting the front side of the light emitting end opening 31 or picking up an image. Further, through modification of the composition of the plastic material 20, characteristics, such as temperature resistance or alkali/acid resistance, may be provided for further applications in diverse fields, such as medical purposes (high temperature sterilization), maintenance and assembling of machinery, and the likes.

Further, the embodiment of the present invention does not need to additionally mount a light source to an outside surface thereof, so that no weight concentration at an end of the tube may occur, avoiding a projecting light emitting object is not required in the operation thereof, and thus the convenience of operation and control is significantly improved. For application in invading treatments, only an opening that is of a size substantially the same as the diameter of the tube needs to be formed in the human body. Compared to an opening formed in the human body for use of the conventional device that requires an additionally mounted the light source, the incision opening made for use of the embodiment of the present invention is smaller.

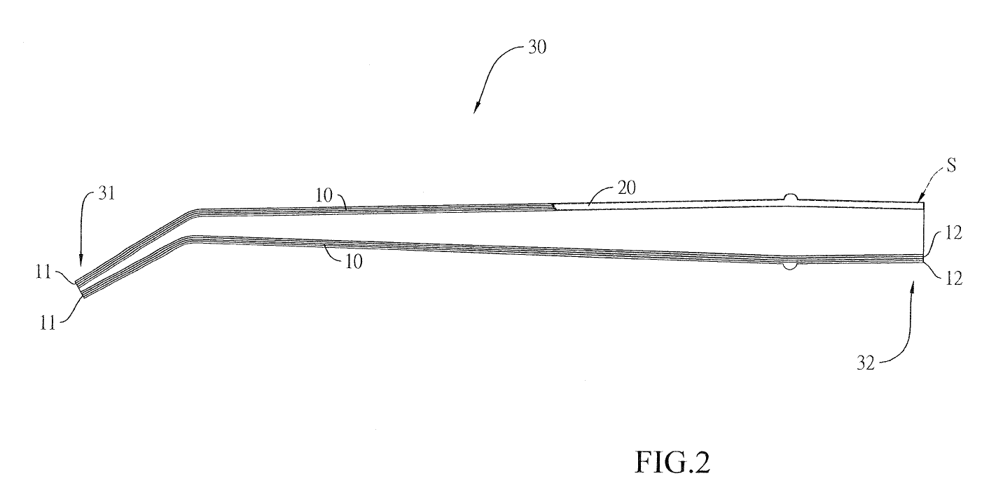

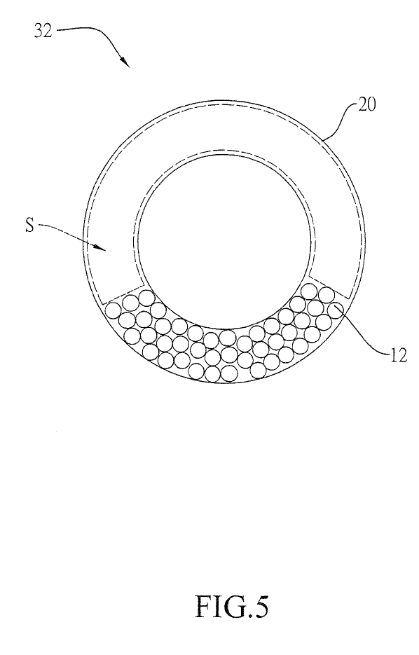

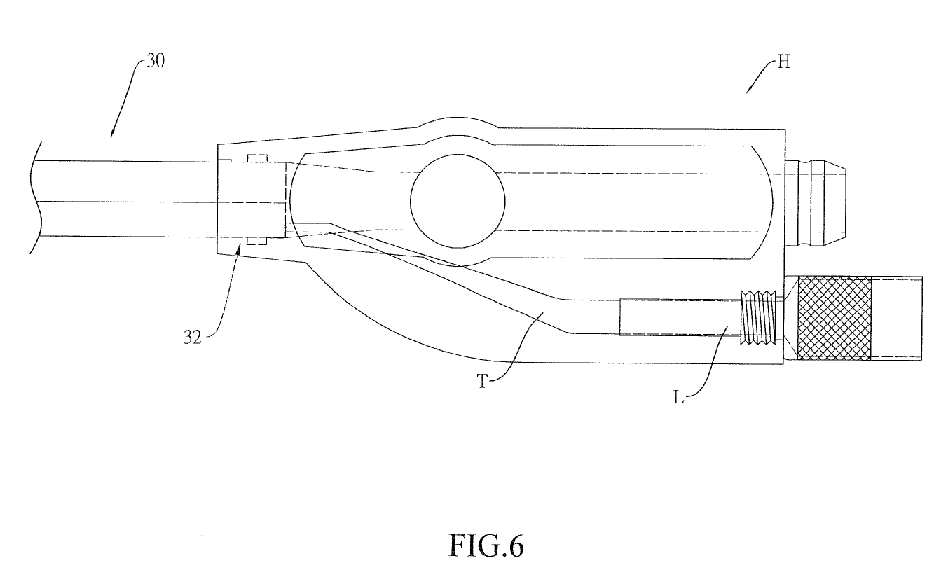

Referring to FIGS. 2, 3, and 5, the light entrance ends 12 may be arranged to concentrate at one portion of the light receiving end opening 32 with each of the light entrance ends 12 facing outward of the light receiving end opening 32. As such, a single light source may irradiate all the light entrance ends 12 at the same time. Referring to FIG. 6, the embodiment of the present invention may be fit to a handgrip H, where the handgrip H contains therein a light source L and a transmitting medium T that has an end positioned on the light source L and an opposite end positioned on the light receiving end opening 32. The light source L emits a light that transmits through the transmitting medium T into the light receiving end opening 32, whereby the light exit ends 11 are irradiated by the light. Further, in a portion of the plastic material 20 within which none of the optical fibers 10 is set (namely the area marked S in FIGS. 2 and 5), materials, such as silica, zircon, or fibrous substances (not shown), are selectively added to improve the strength of the area S.

Since the light entrance ends 12 are concentrated at a certain portion, only a single light source L is sufficient to irradiate light to the light entrance ends 12, whereby the consumption of electrical power can be reduced and the number of light sources L can also be reduced. Further, the transmitting medium T is not a necessary component and can be omitted, whereby the light source L is positioned at a location close to or adjacent to the light entrance ends 12 to allow the light to directly enter the optical fibers 10.

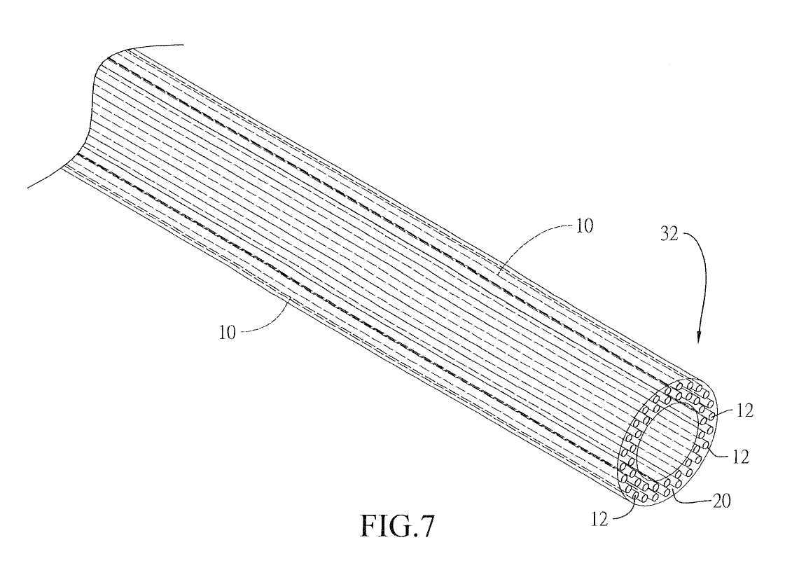

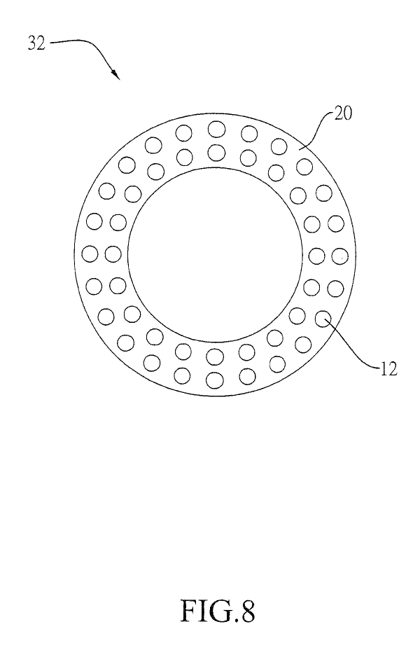

Referring to FIGS. 7 and 8, the light entrance ends 12 may be arranged to distribute in, and preferably along, the light receiving end opening 32, and each of the light entrance ends 12 face outward of the light receiving end opening 32. As such, multiple light sources may be used to cope with the needs in various situations. An alternative arrangement of light source L′ illustrated 9 is provided in a circular or ring like form to correspond to the arrangement of the light entrance ends 12 shown in FIG. 6. As such, each of the light entrance ends 12 can be properly irradiated by light. Certainly, it is possible to use a single light source in combination with multiple transmitting media to conduct light to each of the light entrance ends 12. Light sources of various designs are available and the present invention allows the optical fibers 10 to be arranged in various forms to correspond to the designs of the light sources. Thus, the present invention can be practiced according to the light source available and is not limited to any specific form.

Further, the optical fibers 10 can be optic micro-fibers or any kind of fibers that may be used to transmit light. The arrangement and distribution of the optical fibers 10 is not limited to any specific limitation or constrain and parallel or intersecting arrangement may be applied as desired to improve force resistance or toughness of the present invention as a whole.

The plastic material can be thermosetting plastic materials or thermoplastic materials, such as epoxy resin, polyesters, phenolic, acrylic, and vinyl. The plastic material 20 takes a volume ratio of 3%-70% of the tube, while the optical fibers 10 take a volume ratio of 30%-97%.

The embodiment of the present invention is applicable to various fields, such as medical treatments, including oral cavity surgery and endoscope surgery, or being positioned deep between components to perform a cleaning or suction operation, or being used in combination with an image pick-up device that is attached to the light entrance end 12 to pick up an image in front of the light exit end 11 through the optical fibers 10 and thus getting aware of the situation in the front side.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light-transmittable composite tube, comprising:
a plurality of optical fibers, each of which has a light exit end and a light entrance end, whereby light enters the light entrance end and emits from the light exit end; and
a plastic material, which is set around and combined with side surfaces of the optical fibers in a composite form to fix relative positions of the optical fibers to form a tubular structure serving as a fiber/plastic composite light guide tube, which has a light emitting end opening and a light receiving end opening, the light exit ends being arranged to distribute in the light emitting end opening and facing outward of the light emitting end opening.

2. The light-transmittable composite tube according to claim 1, wherein the light entrance ends are arranged to concentrate in a portion of the light receiving end opening with each of the light entrance ends facing outward of the light receiving end opening.

3. The light-transmittable composite tube according to claim 1, wherein the light exit ends are arranged to distribute in the light emitting end opening with each of the light exit ends facing outward of the light emitting end opening.

4. The light-transmittable composite tube according to claim 1, wherein the plastic material is selected from a group consisting of thermosetting plastic materials and thermoplastic materials.
